(19) United States
(12) Patent Application Publication
(10) Pub. No.: US 2002/0035053 A1
(43) Pub. Date: Mar. 21, 2002

(54) CLEAR LIQUID FABRIC SOFTENING COMPOSITIONS

(76) Inventors: HUGO JEAN-MARIE DEMEYERE, MERCHTEM (BE); MARC JOHAN DECLERCQ, STROMBEEK-BEVER (BE); GAYLE MARIE FRANKENBACH, CINCINNATI, OH (US); ERROL HOFFMAN WAHL, CINCINNATI, OH (US)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(21) Appl. No.: 09/485,989

(22) PCT Filed: Aug. 18, 1997
(86) PCT No.: PCT/US97/14470

(51) Int. Cl. D06L 1/00; C11D 3/00

(52) U.S. Cl. 510/515; 510/327; 510/329

(57) ABSTRACT

The present invention relates to clear or translucent liquid softening compositions. The composition of the invention comprises a fabric softener, a principal solvent and a nonionic alkoxylated surfactant.

### TECHNICAL FIELD OF THE INVENTION

The present invention relates to fabric softening composition useful for softening fabrics. It especially relates to fabric softening compositions suitable for use in the rinse cycle of a textile laundering operation. The compositions of the invention are translucent or clear liquid softening compositions.

### BACKGROUND OF THE INVENTION

Fabric softening compositions, in particular clear liquid fabric softening compositions are known in the art as is their formulation. Hence, WO 97/03169 describes the formulation of liquid fabric softening compositions using specific solvents. The compositions of WO 97/03169 are said to provide excellent fabric-softening/static-control benefits, reduced staining of fabric, excellent water dispersibility, rewettability, and/or storage and viscosity stability at sub-normal temperatures, i.e., temperatures below normal room temperature, e.g., 25° C.

However, it has been found that upon slight level variations of the solvents or even temperature change, the clarity and stability of the resulting compositions was often impaired.

In addition to this, a problem encountered with the use of these solvents is their undesirable odour which at high levels is even more perceptible. Still another problem with these solvents is their relative cost and their low supply capacity.

Accordingly, the formulator of softening compositions is faced with the dual challenge of formulating a clear or translucent composition without being detrimental to the stability and clarity of the liquid softening compositions.

One solution to these problem is to use a high level of organic acid as provided in EP-A-0,404,471. However, this still does not provide complete satisfaction over temperature or level variations.

The Applicant has now found that the use of a specific nonionic surfactant in a softening composition comprising a fabric softener and the specific solvents of WO 97/03169 fulfills this need.

Still another advantage of the invention is that the use of this nonionic surfactant enables a reduction in the solvent level in the softening composition whilst not impairing the performance of the softening compositions.

A further advantage of the invention is that the use of this nonionic surfactant enables the use of wide range of solvents. Indeed, typical solvent for use in clear formulations have a Clog P between 0.15 to 0.64. It has now been found that the level reduction of solvent by use of the nonionic surfactant is also applicable to solvents having a higher Clog P.

Still a further advantage of the invention is that the softening composition of the invention also provides similar benefit to those of WO 97/03169, i.e. fabric-softening/static-control benefits, reduced staining of fabric, excellent water dispersibility, rewettability, and/or storage and viscosity stability at sub-normal temperatures, i.e., temperatures below normal room temperature, e.g., 25° C.

### SUMMARY OF THE INVENTION

The present invention relates to a clear fabric softening composition comprising a fabric softening compound, a principal solvent having a ClogP of from 0.15 to 1.0 and a nonionic alkoxylated surfactant, wherein said nonionic surfactant is selected from:

i)-alkyl or alkylphenol alkoxylated with less than 9 alkoxy moieties;

ii)-alkyl amine alkoxylated with at least 5 alkoxy moieties; and

iii)-block co-polymers obtained by copolymerisation of ethylene oxide and propylene oxide; and

iv)-mixtures thereof.

### DETAILED DESCRIPTION OF THE INVENTION

I-Nonionic alkoxylated surfactant

A nonionic alkoxylated surfactant is an essential component of the invention. Not to be bound by theory, it is believed that the nonionic alkoxylated surfactants help to achieve clear products at low solvents levels by helping to maintain a flexible, yet stable interface with zero curvature. The nonionic surfactants will reduce the interfacial tension at the hydrophobic-water interface, thus promoting flexibility, while enhancing packing efficiency at the interface and therefore promoting interfacial stability. Due to the tendency of the nonionic surfactant head group to become highly hydrated, the surfactant will help to get to net zero curvature by filling void spaces in the pallisade layer.

By “pallisade layer”, it is meant the area between hydrophilic groups and the first few carbon atoms in the hydrophobic layer (M. J Rosen, Surfactants and interfacial phenomena, Second Edition, page 172).

Typical levels of incorporation of the nonionic alkoxylated surfactant in the softening compositions are of less than 10% by weight, preferably from 0.1% to 7% by weight, more preferably from 2% to 5% by weight of the composition.

The nonionic alkoxylated compounds described herein differ from the principal solvents described hereinafter by their surfactancy properties. Of course, for the purpose of the present invention, these nonionic alkoxylated compounds are not principal solvent as defined herein.

By “surfactant”, it is meant a substance which, when present at low concentrations in a system, has the property of adsorbing onto surfaces or interfaces of the system and of altering to a marked degree the surface or interfacial free energies of those surfaces or interfaces. (M. J Rosen, Surfactants and interfacial phenomena, Second Edition, page 1).

Preferably, for the purpose of the invention, the nonionic alkoxylated surfactants have a critical micelle concentration (CMC) of less than 10⁻²M. The CMC being defined in M. J ROSEN, Surfactants and interfacial phenomena, 1988, p.215.

The nonionic alkoxylated surfactant for use herein is selected from:

i)-alkyl or alkylphenol alkoxylated with less than 9 alkoxy moieties;

ii)-alkyl amine alkoxylated with at least 5 alkoxy moieties; and

iii)-block co-polymers obtained by copolymerisation of ethylene oxide and propylene oxide; and

iv)-mixtures thereof.

i)-Suitable alkyl phenol alkoxylated with less than 9 alkoxy moieties are the polyethylene oxide condensates of alkyl phenols, e.g., the condensation products of alkyl phenols having an alkyl or alkenyl group containing from 6 to 20 carbon atoms in a primary, secondary or branched chain configuration, preferably from 8 to 12 carbon atoms, with ethylene oxide, the said ethylene oxide being preferably present in amounts equal to 3 to less than 9 moles of ethylene oxide per mole of alkyl phenol. The alkyl substituent in such compounds may be derived from polymerized propylene, diisobutylene, octane, and nonane. Examples of this type of nonionic surfactants include Triton N-57® a nonyl phenol ethoxylate (5EO) from Rohm & Haas, Dowfax® 9N5 from Dow and Lutensol® AP6 from BASF.

Still other suitable nonionic alkoxylated surfactants are the alcohols alkoxylated with less than 9 alkoxy moieties. Typical of this class are the aliphatic alcohols having from 6 to 22 carbon atoms alkoxylated with less than 9 alkoxy moieties. The aliphatic alcohols for use herein have from 6 to 22 carbon atoms, and are in either straight chain or branched chain configuration, preferably from 8 to 18 carbon atoms, with less than 9 moles of ethylene oxide, preferably from 2 to 7, and more preferably is from 3 to 6 on the average.

Preferably, the condensation product of aliphatic alcohols compounds of this class are surfactants of the general formula:

—R²—Y—(C₂H₄O)_{z}—H

wherein R² is selected from the group consisting of primary, secondary and branched chain alkyl and/or acyl hydrocarbyl groups; primary, secondary and branched chain alkenyl hydrocarbyl groups; said hydrocarbyl groups preferably having a hydrocarbyl chain length of from 6 to 20, preferably from 8 to 18 carbon atoms. More preferably the hydrocarbyl chain length is from 10 to 15 carbon atoms. In the general formula for the ethoxylated nonionic surfactants herein, Y is —O—, —C(O)O—, and z is less than 9, preferably from 2 to 7, and more preferably is 3 to 6 on the average.

Examples of nonionic surfactants of this class follow. In the examples, the integer defines the number of ethoxy (EO) groups in the molecule.

a. Straight-Chain, Primary Alcohol Alkoxylates

The tri-, penta-, hepta-ethoxylates of dodecanol, and tetradecanol are useful surfactants in the context of this invention. The ethoxylates of mixed natural or synthetic alcohols in the “coco” chain length range are also useful herein. Commercially available straight-chain, primary alcohol alkoxylates for use herein are available under the tradename Marlipal® 24/70 from Huls, and Genapol® C-050 from Hoechst.

b. Straight-Chain, Secondary Alcohol Alkoxylates

The tri-, penta-, hepta-ethoxylates of 3-hexadecanol, 2-octadecanol, 4-eicosanol, and 5-eicosanol are useful surfactants in the context of this invention.

A commercially available straight-chain secondary alcohol ethoxylate for use herein is the material marketed under the tradename Tergitol 15-S-7 from Union Carbide, which comprises a mixture of secondary alcohols having an average hydrocarbyl chain length of 11 to 15 carbon atoms condensed with an average 7 moles of ethylene oxide per mole equivalent of alcohol.

c. Olefinic Alkoxylates

The alkenyl alcohols, both primary and secondary, and alkenyl phenols corresponding to those disclosed immediately hereinabove can be ethoxylated and used as surfactants.

Commercially available olefinic alkoxylates for use herein are available under the tradename Genapol O-050 from Hoechst.

d. Branched Chain Alkoxylates

Branched chain primary and secondary alcohols which may be available from the well-known “OXO” process or modification thereof can be ethoxylated.

Particularly preferred among these ethoxylates of the primary OXO alcohols are the surfactants marketed under the name Lutensol by BASF or Dobanol by the Shell Chemicals, U.K., LTD. The preferred Dobanols are primary alcohols with hydrocarbyl groups of 9 to 15 carbon atoms, with the majority having a hydrocarbyl group of 13 carbon atoms. Particularly preferred are Dobanols with an average degree of ethoxylation of 3 to less than 9, and preferably 5 on the average.

An example of this type of material is an aliphatic alcohol ethylene oxide condensate having from 3 to less than 9 moles of ethylene oxide per mole of aliphatic alcohol, the aliphatic alcohol fraction having from 9 to 14 carbon atoms. Other examples of this type of nonionic surfactants include certain of the commercially available Dobanol®, Neodol® marketed by Shell or Lutensol® from BASF. For example Dobanol® 23.5 (C12-C13 EO5), Dobanol® 91.5 (C9-C11 EO 5) and and Neodol 45 E5.

ii)-Other suitable nonionic alkoxylated surfactants are alkyl amines alkoxylated with at least 5 alkoxy moieties. Typical of this class of compounds are the surfactants derived from the condensation of ethylene oxide with an hydrophobic alkyl amine product. Preferably the hydrophobic alkyl group, has from 6 to 22 carbon atoms. Preferably, the alkyl amine is alkoxylated with 10 to 40, and more preferably 20 to 30 alkoxy moieties.

Example of this type of nonionic surfactants are the alkyl amine ethoxylate commercially available under the tradename Genamin from Hoechst. Suitable example for use herein are Genamin C-100, Genamin O-150, and Genamin S-200.

Still other suitable type of nonionic surfactant among this class are the N,N′,N′-polyoxyethylene (12)-N-tallow 1,3 diaminopropane commercialised under the tradename Ethoduomeen T22 from Akzo, and Synprolam from ICI.

(iii)-The block co-polymers obtained by copolymerisation of ethylene oxide and propylene oxide is another suitable class of nonionic alkoxylated surfactants suitable for use in the present invention. Typical compounds among this class are the condensation products of ethylene oxide with a hydrophobic base formed by the condensation of propylene oxide with propylene glycol. The hydrophobic portion of these compounds will preferably have a molecular weight of from 1500 to 1800 and will exhibit water insolubility. The addition of polyoxyethylene moieties to this hydrophobic portion tends to increase the water solubility of the molecule as a whole, and the liquid character of the product is retained up to the point where the polyoxyethylene content is 50% of the total weight of the condensation product, which corresponds to condensation with up to 40 moles of ethylene oxide. Examples of compounds of this type include certain of the commercially available Pluronic™ surfactants, marketed by BASF. For example Pluronic PE 4300.

The above ethoxylated nonionic surfactants are useful in the present process invention alone or in combination, and the term “nonionic surfactant” encompasses mixed nonionic surface active agents.

A preferred class of compound for the purpose of the invention is that of condensation product of aliphatic alcohol defined under i), in particular the sub-class of branched chain alkoxylates. Indeed, this particular sub-class of compound has been found more efficient for reducing the level of solvent.

In term of principal solvent reduction, with the invention compositions, a reduction of at least 30% can be made without impairing the performance of the composition compared to compositions without the nonionic alkoxylated surfactant hereinbefore described. Using the preferred sub-class, a reduction of more than 50% was obtained.

II-Fabric softening compound

The composition of the invention also comprise a fabric softening compound as an essential component.

Typical levels of incorporation of the softening compound in the softening composition are of from 1% to 80% by weight, preferably from 5% to 75%, more preferably from 15% to 70%, and even more preferably from 19% to 65%, by weight of the composition.

The fabric softener compound is preferably selected from a cationic, nonionic, amphoteric or anionic fabric softening component.

Typical of the cationic softening components are the quaternary ammonium compounds or amine precursors thereof as defined hereinafter.

A)-Quaternary Ammonium Fabric Softening Active Compound

(1) Preferred quaternary ammonium fabric softening active compound have the formula

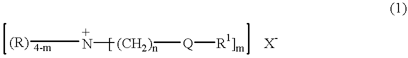

or the formula:

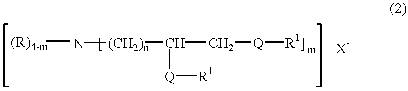

wherein Q is a carbonyl unit having the formula:

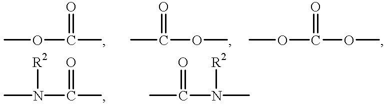

each R unit is independently hydrogen, C₁-C₆ alkyl, C₁-C₆ hydroxyalkyl, and mixtures thereof, preferably methyl or hydroxy alkyl; each R¹ unit is independently linear or branched C₁₁-C₂₂ alkyl, linear or branched C₁₁-C₂₂ alkenyl, and mixtures thereof, R² is hydrogen, C₁-C₄ alkyl, C₁-C₄ hydroxyalkyl, and mixtures thereof; X is an anion which is compatible with fabric softener actives and adjunct ingredients; the index m is from 1 to 4, preferably 2; the index n is from 1 to 4, preferably 2.

An example of a preferred fabric softener active is a mixture of quaternized amines having the formula:

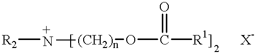

wherein R is preferably methyl; R¹ is a linear or branched alkyl or alkenyl chain comprising at least 11 atoms, preferably at least 15 atoms. In the above fabric softener example, the unit —O₂CR¹ represents a fatty acyl unit which is typically derived from a triglyceride source. The triglyceride source is preferably derived from tallow, partially hydrogenated tallow, lard, partially hydrogenated lard, vegetable oils and/or partially hydrogenated vegetable oils, such as, canola oil, safflower oil, peanut oil, sunflower oil, corn oil, soybean oil, tall oil, rice bran oil, etc. and mixtures of these oils.

The preferred fabric softening actives of the present invention are the Diester and/or Diamide Quaternary Ammonium (DEQA) compounds, the diesters and diamides having the formula:

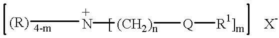

wherein R, R¹, X, and n are the same as defined herein above for formulas (1) and (2), and Q has the formula:

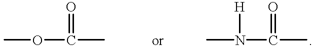

These preferred fabric softening actives are formed from the reaction of an amine with a fatty acyl unit to form an amine intermediate having the formula:

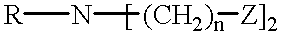

wherein R is preferably methyl, Z is —OH, —NH₂, or mixtures thereof; followed by quaternization to the final softener active.

Non-limiting examples of preferred amines which are used to form the DEQA fabric softening actives according to the present invention include methyl bis(2-hydroxyethyl)amine having the formula:

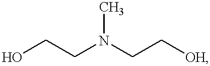

methyl bis(2-hydroxypropyl)amine having the formula:

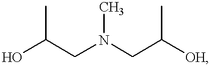

methyl (3-aminopropyl) (2-hydroxyethyl)amine having the formula:

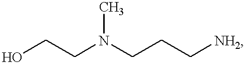

methyl bis(2-aminoethyl)amine having the formula:

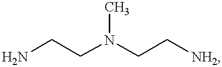

triethanol amine having the formula:

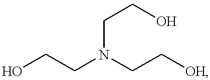

di(2-aminoethyl) ethanolamine having the formula:

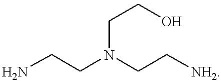

The counterion, X⁽⁻⁾ above, can be any softener-compatible anion, preferably the anion of a strong acid, for example, chloride, bromide, methylsulfate, ethylsulfate, sulfate, nitrate and the like, more preferably chloride or methyl sulfate. The anion can also, but less preferably, carry a double charge in which case X⁽⁻⁾ represents half a group.

Tallow and canola oil are convenient and inexpensive sources of fatty acyl units which are suitable for use in the present invention as R¹ units. The following are non-limiting examples of quaternary ammonium compounds suitable for use in the compositions of the present invention. The term “tallowyl” as used herein below indicates the R¹ unit is derived from a tallow triglyceride source and is a mixture of fatty acyl units. Likewise, the use of the term canolyl refers to a mixture of fatty acyl units derived from canola oil.

TABLE II
Fabric Softener Actives

N,N-di(tallowyl-oxy-ethyl)-N,N-dimethyl ammonium chloride;
N,N-di(canolyl-oxy-ethyl)-N,N-dimethyl ammonium chloride;
N,N-di(tallowyl-oxy-ethyl)-N-methyl N-(2-hydroxyethyl) ammonium
chloride;
N,N-di(canolyl-oxy-ethyl)-N-methyl, N-(2-hydroxyethyl) ammonium
chloride;
N,N-di(2-tallowyloxy-2-oxo-ethyl)-N,N-dimethyl ammonium chloride;
N,N-di(2-canolyloxy-2-oxo-ethyl)-N,N-dimethyl ammonium chloride
N,N-di(2-tallowyloxyethylcarbonyloxyethyl)-N,N-dimethyl ammonium
chloride;
N,N-di(2-canolyloxyethylcarbonyloxyethyl)-N,N-dimethyl ammonium
chloride;
N-(2-tallowoyloxy-2-ethyl)-N-(2-tallowyloxy-2-oxo-ethyl)-N,N-dimethyl
ammonium chloride;
N-(2-canolyloxy-2-ethyl)-N-(2-canolyloxy-2-oxo-ethyl)-N,N-dimethyl
ammonium chloride;
N,N,N-tri(tallowyl-oxy-ethyl)-N-methyl ammonium chloride;
N,N,N-tricanolyl-oxy-ethyl)-N-methyl ammonium chloride;
N-(2-tallowyloxy-2-oxoethyl)-N-(tallowyl)-N,N-dimethyl ammonium
chloride;
N-(2-canolyloxy-2-oxoethyl)-N-(canolyl)-N,N-dimethyl ammonium
chloride;
1,2-ditallowyloxy-3-N,N,N-trimethylammon iopropane chloride; and
1,2-dicanolyloxy-3-N,N,N-trimethylammoniopropane chloride;
and mixtures of the above actives.

Other examples of quaternay ammoniun softening compounds are methylbis(tallowamidoethyl)(2-hydroxyethyl)ammonium methylsulfate and methylbis(hydrogenated tallowamidoethyl)(2-hydroxyethyl)ammonium methylsulfate; these materials are available from Witco Chemical Company under the trade names Varisoft® 222 and Varisoft® 110, respectively.

Particularly preferred are N,N-di(canolyl-oxy-ethyl)-N,N-dimethyl ammonium chloride and N,N-di(canolyl-oxy-ethyl)-N-methyl, N-(2-hydroxyethyl) ammonium methyl sulfate.

The level of unsaturation contained within the tallow, canola, or other fatty acyl unit chain can be measured by the iodine Value (IV) of the corresponding fatty acid, which in the present case should preferably be in the range of from 5 to 100 with two categories of compounds being distinguished, having a IV below or above 25.

Indeed, for compounds having the formula:

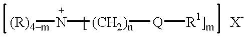

derived from tallow fatty acids, when the Iodine Value is from 5 to 25, preferably 15 to 20, it has been found that a cis/trans isomer weight ratio greater than about 30/70, preferably greater than about 50/50 and more preferably greater than about 70/30 provides optimal concentrability.

For compounds of this type made from tallow fatty acids having a Iodine Value of above 25, the ratio of cis to trans isomers has been found to be less critical unless very high concentrations are needed.

Other suitable examples of fabric softener actives are derived from fatty acyl groups wherein the terms “tallowyl” and canolyl” in the above examples are replaced by the terms “cocoyl, palmyl, lauryl, oleyl, ricinoleyl, stearyl, palmityl,” which correspond to the triglyceride source from which the fatty acyl units are derived. These alternative fatty acyl sources can comprise either fully saturated, or preferably at least partly unsaturated chains.

As described herein before, R units are preferably methyl, however, suitable fabric softener actives are described by replacing the term “methyl” in the above examples in Table II with the units “ethyl, ethoxy, propyl, propoxy, isopropyl, butyl, isobutyl and t-butyl.

The counter ion, X, in the examples of Table II can be suitably replaced by bromide, methylsulfate, formate, sulfate, nitrate, and mixtures thereof. In fact, the anion, X, is merely present as a counterion of the positively charged quaternary ammonium compounds. The scope of this invention is not considered limited to any particular anion.

For the preceding ester fabric softening agents, the pH of the compositions herein is an important parameter of the present invention. Indeed, it influences the stability of the quaternary ammonium or amine precursors compounds, especially in prolonged storage conditions.

The pH, as defined in the present context, is measured in the neat compositions at 20° C. While these compositions are operable at pH of less than about 6.0, for optimum hydrolytic stability of these compositions, the neat pH, measured in the above-mentioned conditions, must preferably be in the range of from about 2.0 to about 5, preferably in the range of 2.5 to 4.5, preferably about 2.5 to about 3.5. The pH of these compositions herein can be regulated by the addition of a Bronsted acid.

Examples of suitable acids include the inorganic mineral acids, carboxylic acids, in particular the low molecular weight (C₁-C₅) carboxylic acids, and alkylsulfonic acids. Suitable inorganic acids include HCl, H₂SO₄, HNO₃ and H₃PO₄. Suitable organic acids include formic, acetic, citric, methylsulfonic and ethylsulfonic acid. Preferred acids are citric, hydrochloric, phosphoric, formic, methylsulfonic acid, and benzoic acids.

As used herein, when the diester is specified, it will include the monoester that is normally present in manufacture. For softening, under no/low detergent carry-over laundry conditions the percentage of monoester should be as low as possible, preferably no more than about 2.5%. However, under high detergent carry-over conditions, some monoester is preferred. The overall ratios of diester to monoester are from about 100:1 to about 2:1, preferably from about 50:1 to about 5:1, more preferably from about 13:1 to about 8:1. Under high detergent carry-over conditions, the di/monoester ratio is preferably about 11:1. The level of monoester present can be controlled in the manufacturing of the softener compound.

One preferred fabric softening compound for use in the present invention is a compound derived from the reaction product of (partly) unsaturated fatty acid with Triethanolamine, di-Me sulfate quaternised (as described in co-pending application PCT/US97/09130 incorporated herein by reference).

Branched chain fatty acids that can be used in the preparation of the DEQA fabric softening compounds herein and examples of their synthesis are described in copending U.S. patent application Ser. No. 08/679,694, of Errol H. Wahl, Toan Trinh, Eugene P. Gosselink, and Mark R. Sivik, filed Jul. 11, 1996 for FABRIC SOFTENING COMPOUND/COMPOSITIONS, equivalent to PCT/US97/03374, said applications being incorporated herein by reference.

DEQA fabric softening compounds as described herein before and their synthesis are described in WO 97/03169 incorporated herein by reference. Other DEQA fabric softening compounds described herein that can be used in the preparation of the fabric softening composition herein and having desirable levels of unsaturation, and their syntheses, are described in copending U.S. patent application Ser. No. 08/620,775, of Errol H. Wahl, Helen B. Tordil, Toan Trinh, and Eugene R. Carr, filed Mar. 22, 1996 for CONCENTRATED FABRIC SOFTENING COMPOSITION WITH GOOD FREEZE/THAW RECOVERY AND UNSATURATED FABRIC SOFTENER COMPOUND THEREFOR, equivalent to PCT/US97/05097 said applications being incorporated herein by reference.

Mixtures of actives of formula (1) and (2) may also be prepared.

2)-Still other suitable quaternary ammonium fabric softening compounds for use herein are cationic nitrogenous salts having two or more long chain acyclic aliphatic C₈-C₂₂ hydrocarbon groups or one said group and an arylalkyl group which can be used either alone or as part of a mixture are selected from the group consisting of:

(i) acyclic quaternary ammonium salts having the formula:

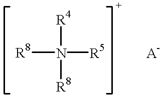

wherein R⁴ is an acyclic aliphatic C₈-C₂₂ hydrocarbon group, R⁵ is a C₁-C₄ saturated alkyl or hydroxyalkyl group, R⁸ is selected from the group consisting of R⁴ and R⁵ groups, and A− is an anion defined as above;

(ii) diamino alkoxylated quaternary ammonium salts having the formula:

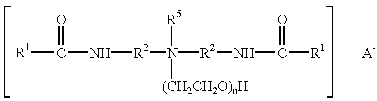

wherein n is equal to 1 to about 5, and R¹, R², R⁵ and A⁻ are as defined above;

(iii) mixtures thereof.

Examples of the above class cationic nitrogenous salts are the well-known dialkyldi methylammonium salts such as ditallowdimethylammonium chloride, ditallowdimethylammonium methylsulfate, di(hydrogenatedtallow)dimethylammonium chloride, distearyldimethylammonium chloride, dibehenyldimethylammonium chloride. Di(hydrogenatedtallow)di methylammonium chloride and ditallowdimethylammonium chloride are preferred. Examples of commercially available dialkyldimethyl ammonium salts usable in the present invention are di(hydrogenatedtallow)dimethylammonium chloride (trade name Adogen® 442), ditallowdimethylammonium chloride (trade name Adogen® 470, Praepagen® 3445), distearyl dimethylammonium chloride (trade name Arosurf® TA-100), all available from Witco Chemical Company. Dibehenyldimethylammonium chloride is sold under the trade name Kemamine Q-2802C by Humko Chemical Division of Witco Chemical Corporation. Dimethylstearylbenzyl ammonium chloride is sold under the trade names Varisoft® SDC by Witco Chemical Company and Ammonyx® 490 by Onyx Chemical Company.

B)-Amine Fabric Softening Active Compound

Suitable amine fabric softening compounds for use herein, which may be in amine form or cationic form are selected from:

(i)-Reaction products of higher fatty acids with a polyamine selected from the group consisting of hydroxyalkylalkylenediamines and dialkylenetriamines and mixtures thereof. These reaction products are mixtures of several compounds in view of the multi-functional structure of the polyamines

The preferred Component (i) is a nitrogenous compound selected from the group consisting of the reaction product mixtures or some selected components of the mixtures.

One preferred Component (i) are reaction products of substantially unsaturated and/or branched chain higher fatty acids with dialkylenetriamines in, e.g., a molecular ratio of about 2:1, said reaction products containing compounds of the formula:

R¹—C(O)—NH—R²—NH—R²—NH—C(O)—R¹

wherein each R¹ and R² are defined as above, and subsequently neutralized with an acid having the anion X⁻.

An example of Component (i) is reaction products of oleic acids with diethylenetriamine in a molecular ratio of about 2:1, said reaction product mixture containing N,N″-dioleoyldiethylenetriamine with the formula:

R¹—C(O)—NH—CH₂CH₂—NH—CH₂CH₂—NH—C(O)—R¹

wherein R¹—C(O) is oleoyl group of a commercially available oleic acid derived from a vegetable or animal source, such as Emersol® 223LL or Emersol® 7021, available from Henkel Corporation, and R² and R³ are divalent ethylene groups.

Another preferred component (i) is a compound of formula:

[R¹—C(O)—NR—R²—NRH—R²—NR—C(O)—R¹]⁺A⁻

wherein each R, R¹, R², and A⁻ are defined as above.

An example of Compound (i) is a difatty amidoamine based softener having the formula:

[R¹—C(O)—NH—CH₂CH₂—NH(CH₂CH₂OH)—CH₂CH₂—NH—C(O)—R¹]⁺Cl⁻

wherein R¹—C(O) is oleoyl group.

Still another preferred component (i) is a compound selected from the group consisting of substituted imidazoline compounds having the formula:

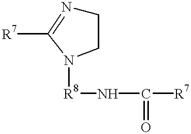

wherein R⁷ is an acyclic aliphatic C₁₅-C₂₁ hydrocarbon group and R⁸ is a divalent C₁-C₃ alkylene group.

Component (i) materials are commercially available as: Mazamide® 6, sold by Mazer Chemicals, or Ceranine® HC, sold by Sandoz Colors & Chemicals; stearic hydroxyethyl imidazoline sold under the trade names of Alkazine® ST by Alkaril Chemicals, Inc., or Schercozoline® S by Scher Chemicals, Inc.; N,N″-ditallowalkoyldiethylenetriamine; 1-tallowamidoethyl-2-tallowimidazoline (wherein in the preceding structure R¹ is an aliphatic C₁₅-C₁₇ hydrocarbon group and R⁸ is a divalent ethylene group).

Certain of the Components (i) can also be first dispersed in a Bronsted acid dispersing aid having a pKa value of not greater than about 4; provided that the pH of the final composition is not greater than about 6. Some preferred dispersing aids are hydrochloric acid, phosphoric acid, or methylsulfonic acid.

Both N,N″-ditallowalkoyldiethylenetriamine and 1-tallow(amidoethyl)-2-tallowimidazoline are reaction products of tallow fatty acids and diethylenetriamine, and are precursors of the cationic fabric softening agent methyl-1-tallowamidoethyl-2-tallowimidazolinium methylsulfate (see “Cationic Surface Active Agents as Fabric Softeners,” R. R. Egan, Journal of the American Oil Chemicals' Society, January 1978, pages 118-121). N,N″-ditallow alkoyldiethylenetriamine and 1-tallowamidoethyl-2-tallowimidazoline can be obtained from Witco Chemical Company as experimental chemicals. Methyl-1-tallowamidoethyl-2-tallowimidazolinium methylsulfate is sold by Witco Chemical Company under the tradename Varisoft® 475.

(ii)-softener having the formula:

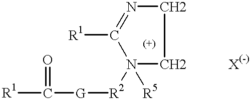

wherein each R² is a C₁₋₆ alkylene group, preferably an ethylene group; and G is an oxygen atom or an —NR— group; and each R, R¹, R² and R⁵ have the definitions given above and A⁻ has the definitions given above for X⁻.

An example of Compound (ii) is 1-oleylamidoethyl-2-oleylimidazolinium chloride wherein R¹ is an acyclic aliphatic C₁₅-C₁₇ hydrocarbon group, R² is an ethylene group, G is a NH group, R⁵ is a methyl group and A⁻ is a chloride anion.

(iii)-the reaction product of substantially unsaturated and/or branched chain higher fatty acid with triethanolamine, and subsequently neutralized with an acid having the anion A⁻.

An example of Compound (iii) is reaction products of oleic acids with N-2-hydroxyethylethylenediamine in a molecular ratio of about 2:1, said reaction product mixture containing a compound of the formula:

R¹—C(O)—NH—CH₂CH₂—N(CH₂CH₂OH)—C(O)—R¹

wherein R¹—C(O) is oleoyl group of a commercially available oleic acid derived from a vegetable or animal source, such as Emersol® 223LL or Emersol® 7021, available from Henkel Corporation.

(iv) softener having the formula:

[chemical structure]

wherein R, R¹, R², and A⁻ are defined as above.

An example of Compound (iv) is the compound having the formula:

[chemical structure]

wherein R¹ is derived from oleic acid.

Additional fabric softening agents useful herein are described in U.S. Pat. No. 4,661,269, issued Apr. 28, 1987, in the names of Toan Trinh, Errol H. Wahl, Donald M. Swartley, and Ronald L. Hemingway; U.S. Pat. No. 4,439,335, Burns, issued Mar. 27, 1984; and in U.S. Pat. Nos.: 3,861,870, Edwards and Diehl; 4,308,151, Cambre; 3,886,075, Bernardino; 4,233,164, Davis; 4,401,578, Verbruggen; 3,974,076, Wiersema and Rieke; 4,237,016, Rudkin, Clint, and Young; and European Patent Application publication No. 472,178, by Yamamura et al., all of said documents being incorporated herein by reference.

Of course, the term “softening active” can also encompass mixed softening active agents.

Preferred among the classes of softener compounds disclosed herein before are the diester or diamido quaternary ammonium fabric softening active compound (DEQA).

The fabric softener actives herein described are employed in clear or translucent formulations.

III-Principal solvent

A principal solvent is another essential ingredient for use in the present composition invention. The principal solvent is typically used at a level of less than 40% by weight, preferably from 5% to 25%, more preferably from 6% to 12%, by weight of the composition. An advantage of the present invention is that the use of the specific nonionic enables the use of a lower level of solvents, that is of less than 15% by weight of the composition, which is preferred for odour, safety and economy reasons. Furthermore, it has been found that in the absence of the nonionic as defined hereinbefore, this low level of principal solvent is insufficient to provide good clarity of the composition. In contrast, when the nonionic is used in addition to this low level of principal solvent, a composition with good clarity is obtained. In preferred compositions, the level of principal solvent is insufficient to provide the required degree of clarity and/or stability and the addition of the nonionic surfactant provides the desired clarity/stability.

The principal solvent is selected to minimize solvent odor impact in the composition and to provide a low viscosity to the final composition. For example, isopropyl alcohol is not very effective and has a strong odor. n-Propyl alcohol is more effective, but also has a distinct odor. Several butyl alcohols also have odors but can be used for effective clarity/stability, especially when used as part of a principal solvent system to minimize their odor. The alcohols are also selected for optimum low temperature stability, that is they are able to form compositions that are liquid with acceptable low viscosities and translucent, preferably clear, down to 40° F. (4.4° C.) and are able to recover after storage down to 20° F. (6.7° C.).

The suitability of any principal solvent for the formulation of the liquid, preferably clear, fabric softener compositions herein with the requisite stability is surprisingly selective. Suitable solvents can be selected based upon their octanol/water partition coefficient (P). Octanol/water partition coefficient of a principal solvent is the ratio between its equilibrium concentration in octanol and in water. The partition coefficients of the principal solvent ingredients of this invention are conveniently given in the form of their logarithm to the base 10, logP.

The logP of many ingredients has been reported; for example, the Pomona92 database, available from Daylight Chemical Information Systems, Inc. (Daylight CIS), Irvine, Calif., contains many, along with citations to the original literature. However, the logP values are most conveniently calculated by the “CLOGP” program, also available from Daylight CIS. This program also lists experimental logP values when they are available in the Pomona92 database. The “calculated logP” (ClogP) is determined by the fragment approach of Hansch and Leo (cf., A. Leo, in Comprehensive Medicinal Chemistry, Vol. 4, C. Hansch, P. G. Sammens, J. B. Taylor and C. A. Ramsden, Eds., p. 295, Pergamon Press, 1990, incorporated herein by reference). The fragment approach is based on the chemical structure of each ingredient, and takes into account the numbers and types of atoms, the atom connectivity, and chemical bonding. These ClogP values, which are the most reliable and widely used estimates for this physicochemical property, are preferably used instead of the experimental logP values in the selection of the principal solvent ingredients which are useful in the present invention. Other methods that can be used to compute ClogP include, e.g., Crippen's fragmentation method as disclosed in J. Chem. Inf. Comput. Sci., 27, 21 (1987); Viswanadhan's fragmentation method as disclose in J. Chem. Inf. Comput. Sci., 29, 163 (1989); and Broto's method as disclosed in Eur. J. Med. Chem.-Chim. Theor., 19, 71 (1984). The principal solvents herein are selected from those having a ClogP of from 0.15 to 1.0, preferably from 0.15 to 0.64, more preferably from 0.25 to 0.62, and most preferably from 0.40 to 0.60, said principal solvent preferably being at least somewhat asymmetric, and preferably having a melting, or solidification, point that allows it to be liquid at, or near room temperature. Solvents that have a low molecular weight and are biodegradable are also desirable for some purposes. The more assymetric solvents appear to be very desirable, whereas the highly symmetrical solvents such as 1,7-heptanediol, or 1,4-bis(hydroxymethyl) cyclohexane, which have a center of symmetry, appear to be unable to provide the essential clear compositions when used alone, even though their ClogP values fall in the preferred range.

The most preferred principal solvents can be identified by the appearance of the softener vesicles, as observed via cryogenic electron microscopy of the compositions that have been diluted to the concentration used in the rinse. These dilute compositions appear to have dispersions of fabric softener that exhibit a more unilamellar appearance than conventional fabric softener compositions. The closer to uni-lamellar the appearance, the better the compositions seem to perform. These compositions provide surprisingly good fabric softening as compared to similar compositions prepared in the conventional way with the same fabric softener active.

Operable principal solvents are disclosed and listed below which have ClogP values which fall within the requisite range. These include mono-ols, C6 diols, C7 diols, octanediol isomers, butanediol derivatives, trimethylpentanediol isomers, ethylmethylpentanediol isomers, propyl pentanediol isomers, dimethylhexanediol isomers, ethylhexanediol isomers, methylheptanediol isomers, octanediol isomers, nonanediol isomers, alkyl glyceryl ethers, di(hydroxy alkyl) ethers, and aryl glyceryl ethers, aromatic glyceryl ethers, alicyclic diols and derivatives, C₃C₇ diol alkoxylated derivatives, aromatic diols, and unsaturated diols. These principal solvents are all disclosed in WO 97/03169 having the title “CONCENTRATED, STABLE, PREFERABLY CLEAR, FABRIC SOFTENING COMPOSITION” incorporated herein by reference.

Particularly preferred principal solvents include hexanediols such as 1,2-hexanediol; and C8 diols such as 2-ethyl-1,3-hexanediol and 2,2,4-trimethyl-1,3-pentanediol, ethoxylates of 2,2,4-trimethyl-1,3-pentanediol and ethoxylates of 2-ethyl-1,3-hexanediol; phenoxyethanol and 1,2 cyclohexanedimethanol. Most preferred principal solvents for use herein are selected from 2,2,4-trimethyl-1,3-pentanediol, ethoxylates of 2,2,4-trimethyl-1,3-pentanediol, 1,2 hexanediol, 2-ethyl-1,3-hexanediol, phenoxyethanol, butyl carbitol and mixtures thereof. Even most preferred principal solvents for use herein are selected from 2,2,4-trimethyl-1,3-pentanediol, ethoxylates of 2,2,4-trimethyl-1,3-pentanediol, 1,2 hexanediol, 2-ethyl-1,3-hexanediol, phenoxyethanol, and mixtures thereof. Mixtures of principal solvents can also be used for the purpose of the present invention.

The principal solvents are desirably kept to the lowest levels that are feasible in the present compositions for obtaining translucency or clarity. The presence of water exerts an important effect on the need for the principal solvents to achieve clarity of these compositions. The higher the water content, the higher the principal solvent level (relative to the softener level) is needed to attain product clarity. Inversely, the less the water content, the less principal solvent (relative to the softener) is needed. Thus, at low water levels of from 5% to 15%, the softener active-to-principal solvent weight ratio is preferably from 55:45 to 95:5, more preferably from 60:40 to 90:10. At water levels of from 15% to 70%, the softener active-to-principal solvent weight ratio is preferably from 45:55 to 90:10, more preferably from 55:45 to 85:15. But at high water levels of from 70% to 80%, the softener active-to-principal solvent weight ratio is preferably from 30:70 to 80:20, more preferably from 35:65 to 75:25. At even higher water levels, the softener to principal solvent ratios should also be even higher.

The compositions can also inherently provide improved perfume deposition of certain perfume components, especially for those that are poorly fabric substantive as compared to conventional fabric softening compositions, especially when the perfume is added to the compositions at, or near, room temperature.

More preferred for use herein is a combination of principal solvents. Most preferred combinations are 2,2,4-trimethyl-1,3-pentanediol (TMPD) in combination with 1,2 hexanediol or 2-ethyl 1,3 hexanediol. With the above preferred combinations, lower total levels of solvents can be achieved thereby further reducing the overall cost of the formulation. By the present principal solvent combinations, it has been found that the resulting products have increased phase stability and fully recover from freezing down to 0° F. (−18° C.). The resulting products have also been surprisingly found to have excellent water dispersibility.

When in such clear or transluscent liquid forms, it has been found most preferred, in order to improve the stability of the softening composition according to the invention, that the softening compositions have a pH of from 2 to 5, preferably 2.5 to 4.

Fully formulated fabric softening compositions may contain, in addition to the hereinbefore described components, one or more of the following ingredients.

IV-Optional ingredients

(A)-Low molecular weight water soluble solvents

Low molecular weight water soluble solvents can also be used at levels of from 0% to 12%, preferably from 1% to 10%, more preferably from 2% to 8% by weight. The water soluble solvents cannot provide a clear product at the same low levels of the principal solvents described hereinbefore but can provide clear product when the principal solvent is not sufficient to provide completely clear product. The presence of these water soluble solvents is therefore highly desirable. Such solvents include: ethanol; isopropanol; propylene glycol;1,2-propanediol; 1,3-propanediol; propylene carbonate; 1,4 cyclohexanedimethanol; etc. but do not include any of the principal solvents (A). These water soluble solvents have a greater affinity for water in the presence of hydrophobic materials like the softener compound than the principal solvents.

Among the above described co-solvent to be used in combination with the principal solvent, 1,4 cyclohexanedimethanol and/or ethanol are preferred co-solvents.

(B)-Brighteners

The compositions herein can also optionally contain from 0.005% to 5% by weight of certain types of hydrophilic optical brighteners which also provide a dye transfer inhibition action. If used, the compositions herein will preferably comprise from 0.001% to 1% by weight of such optical brighteners.

The hydrophilic optical brighteners useful in the present invention are those having the structural formula:

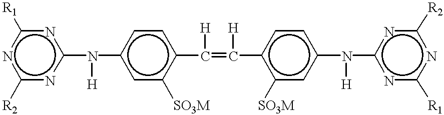

wherein R₁ is selected from anilino, N-2-bis-hydroxyethyl and NH-2-hydroxyethyl; R₂ is selected from N-2-bis-hydroxyethyl, N-2-hydroxyethyl-N-methylamino, morphilino, chloro and amino; and M is a salt-forming cation such as sodium or potassium.

When in the above formula, R₁ is anilino, R₂ is N-2-bis-hydroxyethyl and M is a cation such as sodium, the brightener is 4,4′,-bis[(4-anilino-6-(N-2-bis-hydroxyethyl)-s-triazine-2-yl)amino]-2,2′-stilbenedisulfonic acid and disodium salt. This particular brightener species is commercially marketed under the tradename Tinopal-UNPA-GX® by Ciba-Geigy Corporation. Tinopal-UNPA-GX is the preferred hydrophilic optical brightener useful in the rinse added compositions herein.

When in the above formula, R₁ is anilino, R₂ is N-2-hydroxyethyl-N-2-methylamino and M is a cation such as sodium, the brightener is 4,4′-bis[(4-anilino-6-(N-2-hydroxyethyl-N-methylamino)-s-triazine-2-yl)amino]2,2′-stilbenedisulfonic acid disodium salt. This particular brightener species is commercially marketed under the tradename Tinopal 5BM-GX® by Ciba-Geigy Corporation.

When in the above formula, R₁ is anilino, R₂ is morphilino and M is a cation such as sodium, the brightener is 4,4′-bis[(4-anilino-6-morphilino-s-triazine-2-yl)amino]2,2′-stilbenedisulfonic acid, sodium salt. This particular brightener species is commercially marketed under the tradename Tinopal AMS-GX® by Ciba Geigy Corporation.

(C)-Dispersibility Aids

Relatively concentrated compositions containing both saturated and unsaturated diester quaternary ammonium compounds can be prepared that are stable without the addition of concentration aids. However, the compositions of the present invention may require organic and/or inorganic concentration aids to go to even higher concentrations and/or to meet higher stability standards depending on the other ingredients. These concentration aids which typically can be viscosity modifiers may be needed, or preferred, for ensuring stability under extreme conditions when particular softener active levels are used. The surfactant concentration aids are typically selected from the group consisting of (1) single long chain alkyl cationic surfactants; (2) nonionic surfactants; (3) amine oxides; (4) fatty acids; and (5) mixtures thereof. These aids are described in P&G Copending Application Ser. No. 08/461,207, filed Jun. 5, 1995, Wahl et al., specifically on page 14, line 12 to page 20, line 12, which is herein incorporated by reference.

When said dispersibility aids are present the total level is from 2% to 25%, preferably from 3% to 17%, more preferably from 4% to 15%, and even more preferably from 5% to 13% by weight of the composition. These materials can either be added as part of the active softener raw material, (I), e.g., the mono-long chain alkyl cationic surfactant and/or the fatty acid which are reactants used to form the biodegradable fabric softener active as discussed hereinbefore, or added as a separate component. The total level of dispersibility aid includes any amount that may be present as part of component (I).

(1) Mono-Alkyl Cationic Quaternary Ammonium Compound

When the mono-alkyl cationic quaternary ammonium compound is present, it is typically present at a level of from 2% to 25%, preferably from 3% to 17%, more preferably from 4% to 15%, and even more preferably from 5% to 13% by weight of the composition, the total mono-alkyl cationic quaternary ammonium compound being at least at an effective level.

Such mono-alkyl cationic quaternary ammonium compounds useful in the present invention are, preferably, quaternary ammonium salts of the general formula:

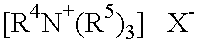

wherein R⁴ is C₈-C₂₂ alkyl or alkenyl group, preferably C₁₀-C₁₈ alkyl or alkenyl group; more preferably C₁₀-C₁₄ or C₁₆-C₁₈ alkyl or alkenyl group;

each R⁵ is a C₁-C₆ alkyl or substituted alkyl group (e.g., hydroxy alkyl), preferably C₁-C₃ alkyl group, e.g., methyl (most preferred), ethyl, propyl, and the like, a benzyl group, hydrogen, a polyethoxylated chain with from 2 to 20 oxyethylene units, preferably from 2.5 to 13 oxyethylene units, more preferably from 3 to 10 oxyethylene units, and mixtures thereof; and X⁻ is as defined hereinbefore for (Formula (I)).

Especially preferred dispersibility aids are monolauryl trimethyl ammonium chloride and monotallow trimethyl ammonium chloride available from Witco under the trade names Adogen® 412 and Adogen® 471, monooleyl or monocanola trimethyl ammonium chloride available from Witco under the tradename Adogen® 417, monococonut trimethyl ammonium chloride available from Witco under the trade name Adogen® 461, and monosoya trimethyl ammonium chloride available from Witco under the trade name Adogen® 415.

The R⁴ group can also be attached to the cationic nitrogen atom through a group containing one, or more, ester, amide, ether, amine, etc., linking groups which can be desirable for increased concentratability of component (i), etc. Such linking groups are preferably within from one to three carbon atoms of the nitrogen atom.

Mono-alkyl cationic quaternary ammonium compounds also include C₈-C₂₂ alkyl choline esters. The preferred dispersibility aids of this type have the formula:

R¹C(O)—O—CH₂CH₂N⁺(R)₃X⁻

wherein R¹, R and X⁻ are as defined previously.

Highly preferred dispersibility aids include C₁₂-C₁₄ coco choline ester and C₁₆-C₁₈ tallow choline ester.

Suitable biodegradable single-long-chain alkyl dispersibility aids containing an ester linkage in the long chains are described in U.S. Pat. No. 4,840,738, Hardy and Walley, issued Jun. 20, 1989, said patent being incorporated herein by reference.

When the dispersibility aid comprises alkyl choline esters, preferably the compositions also contain a small amount, preferably from 2% to 5% by weight of the composition, of organic acid. Organic acids are described in European Patent Application No. 404,471, Machin et al., published on Dec. 27, 1990, supra, which is herein incorporated by reference. Preferably the organic acid is selected from the group consisting of glycolic acid, acetic acid, citric acid, and mixtures thereof.

Ethoxylated quaternary ammonium compounds which can serve as the dispersibility aid include ethylbis(polyethoxy ethanol)alkylammonium ethyl-sulfate with 17 moles of ethylene oxide, available under the trade name Variquat® 66 from Witco Corporation; polyethylene glycol (15) oleammonium chloride, available under the trade name Ethoquad® 0/25 from Akzo; and polyethylene glycol (15) cocomonium chloride, available under the trade name Ethoquad® C/25 from Akzo.

Quaternary compounds having only a single long alkyl chain, can protect the cationic softener from interacting with anionic surfactants and/or detergent builders that are carried over into the rinse from the wash solution.

(2) Nonionic Surfactant (Alkoxylated Materials)

Suitable nonionic surfactants to serve as the viscosity/dispersibility modifier include addition products of ethylene oxide and, optionally, propylene oxide, with fatty alcohols, fatty acids, fatty amines, etc. They are referred to herein as ethoxylated fatty alcohols, ethoxylated fatty acids, and ethoxylated fatty amines. Any of the alkoxylated materials of the particular type described hereinafter can be used as the nonionic surfactant. In general terms, the nonionics herein, when used alone, in liquid compositions are at a level of from 0% to 5%, preferably from 0.1% to 5%, more preferably from 0.2% to 3%. Suitable compounds are substantially water-soluble surfactants of the general formula:

R²—Y—(C₂H₄O)_{z}—C₂H₄OH

wherein R² for both solid and liquid compositions is selected from the group consisting of primary, secondary and branched chain alkyl and/or acyl hydrocarbyl groups; primary, secondary and branched chain alkenyl hydrocarbyl groups; and primary, secondary and branched chain alkyl- and alkenyl-substituted phenolic hydrocarbyl groups; said hydrocarbyl groups having a hydrocarbyl chain length of from 8 to 20, preferably from 10 to 18 carbon atoms. More preferably the hydrocarbyl chain length for liquid compositions is from 16 to 18 carbon atoms and for solid compositions from 10 to 14 carbon atoms. In the general formula for the ethoxylated nonionic surfactants herein, Y is typically —O—, —C(O)O—, preferably —O—, and in which R², when present, have the meanings given hereinbefore, and z is at least 8, preferably at least 10-11. Performance and, usually, stability of the softener composition decrease when fewer ethoxylate groups are present.

The nonionic surfactants herein are characterized by an HLB (hydrophilic-lipophilic balance) of from 7 to 20, preferably from 8 to 15. Of course, by defining R² and the number of ethoxylate groups, the HLB of the surfactant is, in general, determined. However, it is to be noted that the nonionic ethoxylated surfactants useful herein, for concentrated liquid compositions, contain relatively long chain R² groups and are relatively highly ethoxylated. While shorter alkyl chain surfactants having short ethoxylated groups can possess the requisite HLB, they are not as effective herein.

Nonionic surfactants as the viscosity/dispersibility modifiers are preferred over the other modifiers disclosed herein for compositions with higher levels of perfume.

(3) Amine Oxides

Suitable amine oxides include those with one alkyl or hydroxyalkyl moiety of 8 to 22 carbon atoms, preferably from 10 to 18 carbon atoms, more preferably from 8 to 14 carbon atoms, and two alkyl moieties selected from the group consisting of alkyl groups and hydroxyalkyl groups with 1 to 3 carbon atoms.

Examples include dimethyloctylamine oxide, diethyldecylamine oxide, bis-(2-hydroxyethyl)dodecyl-amine oxide, dimethyldodecylamine oxide, dipropyl-tetradecylamine oxide, methylethylhexadecylamine oxide, dimethyl-2-hydroxyoctadecylamine oxide, and coconut fatty alkyl dimethylamine oxide.

(D)-Stabilizers

Stabilizers can be present in the compositions of the present invention. The term “stabilizer,” as used herein, includes antioxidants and reductive agents. These agents are present at a level of from 0% to 2%, preferably from 0.01% to 0.2%. more preferably from 0.035% to 0.1% for antioxidants, and more preferably from 0.01% to 0.2% for reductive agents. These assure good odor stability under long term storage conditions. Antioxidants and reductive agent stabilizers are especially critical for unscented or low scent products (no or low perfume).

Examples of antioxidants that can be added to the compositions of this invention include a mixture of ascorbic acid, ascorbic palmitate, propyl gallate, available from Eastman Chemical Products, Inc., under the trade names Tenox® PG and Tenox® S-1; a mixture of BHT (butylated hydroxytoluene), BHA (butylated hydroxyanisole), propyl gallate, and citric acid, available from Eastman Chemical Products, Inc., under the trade name Tenox®-6; butylated hydroxytoluene, available from UOP Process Division under the trade name Sustane® BHT; tertiary butylhydroquinone, Eastman Chemical Products, Inc., as Tenox® TBHQ; natural tocopherols, Eastman Chemical Products, Inc., as Tenox® GT-1/GT-2; and butylated hydroxyanisole, Eastman Chemical Products, Inc., as BHA; long chain esters (C₈-C₂₂) of gallic acid, e.g., dodecyl gallate; Irganox® 1010; Irganox® 1035; Irganox® B 1171; Irganox® 1425; Irganox® 3114; Irganox® 3125; and mixtures thereof; preferably Irganox® 3125, Irganox® 1425, Irganox® 3114, and mixtures thereof; more preferably Irganox® 3125 alone or mixed with citric acid and/or other chelators such as isopropyl citrate, Dequest® 2010, available from Monsanto with a chemical name of 1-hydroxyethylidene-1,1-diphosphonic acid (etidronic acid), and Tiron®, available from Kodak with a chemical name of 4,5-dihydroxy-m-benzene-sulfonic acid/sodium salt, and DTPA®, available from Aldrich with a chemical name of diethylenetriaminepentaacetic acid.

(E)-Soil Release Agent

In the present invention, an optional soil release agent can be added. The addition of the soil release agent can occur in combination with the premix, in combination with the acid/water seat, before or after electrolyte addition, or after the final composition is made. The softening composition prepared by the process of the present invention herein can contain from 0% to 10%, preferably from 0.2% to 5%, of a soil release agent. Preferably, such a soil release agent is a polymer. Polymeric soil release agents useful in the present invention include copolymeric blocks of terephthalate and polyethylene oxide or polypropylene oxide, and the like.

A preferred soil release agent is a copolymer having blocks of terephthalate and polyethylene oxide. More specifically, these polymers are comprised of repeating units of ethylene terephthalate and polyethylene oxide terephthalate at a molar ratio of ethylene terephthalate units to polyethylene oxide terephthalate units of from 25:75 to 35:65, said polyethylene oxide terephthalate containing polyethylene oxide blocks having molecular weights of from 300 to 2000. The molecular weight of this polymeric soil release agent is in the range of from 5,000 to 55,000.

Another preferred polymeric soil release agent is a crystallizable polyester with repeat units of ethylene terephthalate units containing from 10% to 15% by weight of ethylene terephthalate units together with from 10% to 50% by weight of polyoxyethylene terephthalate units, derived from a polyoxyethylene glycol of average molecular weight of from 300 to 6,000, and the molar ratio of ethylene terephthalate units to polyoxyethylene terephthalate units in the crystallizable polymeric compound is between 2:1 and 6:1. Examples of this polymer include the commercially available materials Zelcon 4780® (from Dupont) and Milease T® (from ICI).

Highly preferred soil release agents are polymers of the generic formula:

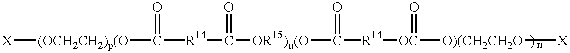

in which each X can be a suitable capping group, with each X typically being selected from the group consisting of H, and alkyl or acyl groups containing from 1 to 4 carbon atoms. p is selected for water solubility and generally is from 6 to 113, preferably from 20 to 50. u is critical to formulation in a liquid composition having a relatively high ionic strength. There should be very little material in which u is greater than 10. Furthermore, there should be at least 20%, preferably at least 40%, of material in which u ranges from 3 to 5.

The R¹⁴ moieties are essentially 1,4-phenylene moieties. As used herein, the term “the R¹⁴ moieties are essentially 1,4-phenylene moieties” refers to compounds where the R¹⁴ moieties consist entirely of 1,4-phenylene moieties, or are partially substituted with other arylene or alkarylene moieties, alkylene moieties, alkenylene moieties, or mixtures thereof. Arylene and alkarylene moieties which can be partially substituted for 1,4-phenylene include 1,3-phenylene, 1,2-phenylene, 1,8-naphthylene, 1,4-naphthylene, 2,2-biphenylene, 4,4-biphenylene, and mixtures thereof. Alkylene and alkenylene moieties which can be partially substituted include 1,2-propylene, 1,4-butylene, 1,5-pentylene, 1,6-hexamethylene, 1,7-heptamethylene, 1,8-octamethylene, 1,4-cyclohexylene, and mixtures thereof.

For the R¹⁴ moieties, the degree of partial substitution with moieties other than 1,4-phenylene should be such that the soil release properties of the compound are not adversely affected to any great extent. Generally the degree of partial substitution which can be tolerated will depend upon the backbone length of the compound, i.e., longer backbones can have greater partial substitution for 1,4-phenylene moieties. Usually, compounds where the R¹⁴ comprise from 50% to 100% 1,4-phenylene moieties (from 0% to 50% moieties other than 1,4-phenylene) have adequate soil release activity. For example, polyesters made according to the present invention with a 40:60 mole ratio of isophthalic (1,3-phenylene) to terephthalic (1,4-phenylene) acid have adequate soil release activity. However, because most polyesters used in fiber making comprise ethylene terephthalate units, it is usually desirable to minimize the degree of partial substitution with moieties other than 1,4-phenylene for best soil release activity. Preferably, the R¹⁴ moieties consist entirely of (i.e., comprise 100%) 1,4-phenylene moieties, i.e., each R¹⁴ moiety is 1,4-phenylene.

For the R¹⁵ moieties, suitable ethylene or substituted ethylene moieties include ethylene, 1,2-propylene, 1,2-butylene, 1,2-hexylene, 3-methoxy-1,2-propylene, and mixtures thereof. Preferably, the R¹⁵ moieties are essentially ethylene moieties, 1,2-propylene moieties, or mixtures thereof. Inclusion of a greater percentage of ethylene moieties tends to improve the soil release activity of compounds. Surprisingly, inclusion of a greater percentage of 1,2-propylene moieties tends to improve the water solubility of compounds.

Therefore, the use of 1,2-propylene moieties or a similar branched equivalent is desirable for incorporation of any substantial part of the soil release component in the liquid fabric softener compositions. Preferably, from 75% to 100%, are 1,2-propylene moieties.

The value for each p is at least 6, and preferably is at least 10. The value for each n usually ranges from 12 to 113. Typically the value for each p is in the range of from 12 to 43.

A more complete disclosure of soil release agents is contained in U.S. Pat. Nos.: 4,661,267; 4,711,730; 4,749,596; 4,818,569; 4,877,896; 4,956,447; and 4,976,879, all of said patents being incorporated herein by reference.

These soil release agents can also act as scum dispersants.

(F)-Scum Dispersant

In the present invention, the premix can be combined with an optional scum dispersant, other than the soil release agent, and heated to a temperature at or above the melting point(s) of the components.

The preferred scum dispersants herein are formed by highly ethoxylating hydrophobic materials. The hydrophobic material can be a fatty alcohol, fatty acid, fatty amine, fatty acid amide, amine oxide, quaternary ammonium compound, or the hydrophobic moieties used to form soil release polymers. The preferred scum dispersants are highly ethoxylated, e.g., more than 17, preferably more than 25, more preferably more than 40, moles of ethylene oxide per molecule on the average, with the polyethylene oxide portion being from 76% to 97%, preferably from 81% to 94%, of the total molecular weight.

The level of scum dispersant is sufficient to keep the scum at an acceptable, preferably unnoticeable to the consumer, level under the conditions of use, but not enough to adversely affect softening. For some purposes it is desirable that the scum is nonexistent. Depending on the amount of anionic or nonionic detergent, etc., used in the wash cycle of a typical laundering process, the efficiency of the rinsing steps prior to the introduction of the compositions herein, and the water hardness, the amount of anionic or nonionic detergent surfactant and detergency builder (especially phosphates and zeolites) entrapped in the fabric (laundry) will vary. Normally, the minimum amount of scum dispersant should be used to avoid adversely affecting softening properties. Typically scum dispersion requires at least 2%, preferably at least 4% (at least 6% and preferably at least 10% for maximum scum avoidance) based upon the level of softener active. However, at levels of 10% (relative to the softener material) or more, one risks loss of softening efficacy of the product especially when the fabrics contain high proportions of nonionic surfactant which has been absorbed during the washing operation.

Preferred scum dispersants are: Brij 700®; Varonic U-250®; Genapol T-500®, Genapol T-800®; Plurafac A-79®; and Neodol 25-50®.

(G)-Bactericides

Examples of bactericides used in the compositions of this invention include glutaraldehyde, formaldehyde, 2-bromo-2-nitro-propane-1,3-diol sold by Inolex Chemicals, located in Philadelphia, Pa., under the trade name Bronopol®, and a mixture of 5-chloro-2-methyl-4-isothiazoline-3-one and 2-methyl-4-isothiazoline-3-one sold by Rohm and Haas Company under the trade name Kathon 1 to 1,000 ppm by weight of the agent.

(H)-Perfume

The present invention can contain any softener compatible perfume. Suitable perfumes are disclosed in U.S. Pat. No. 5,500,138, said patent being incorporated herein by reference.

As used herein, perfume includes fragrant substance or mixture of substances including natural (i.e., obtained by extraction of flowers, herbs, leaves, roots, barks, wood, blossoms or plants), artificial (i.e., a mixture of different nature oils or oil constituents) and synthetic (i.e., synthetically produced) odoriferous substances. Such materials are often accompanied by auxiliary materials, such as fixatives, extenders, stabilizers and solvents. These auxiliaries are also included within the meaning of “perfume”, as used herein. Typically, perfumes are complex mixtures of a plurality of organic compounds.

Examples of perfume ingredients useful in the perfumes of the present invention compositions include, but are not limited to, hexyl cinnamic aldehyde; amyl cinnamic aldehyde; amyl salicylate; hexyl salicylate; terpineol; 3,7-dimethyl-cis-2,6-octadien-1-ol; 2,6-dimethyl-2-octanol; 2,6-dimethyl-7-octen-2-ol; 3,7-dimethyl-3-octanol; 3,7-dimethyl-trans-2,6-octadien-1-ol; 3,7-dimethyl-6-octen-1-ol; 3,7-dimethyl-1-octanol; 2-methyl-3-(para-tert-butylphenyl)-propionaldehyde; 4-(4-hydroxy-4-methylpentyl)-3-cyclohexene-1-carboxaldehyde; tricyclodecenyl propionate; tricyclodecenyl acetate; anisaldehyde; 2-methyl-2-(para-iso-propylphenyl)-propionaldehyde; ethyl-3-methyl-3-phenyl glycidate; 4-(para-hydroxyphenyl)-butan-2-one; 1-(2,6,6-trimethyl-2-cyclohexen-1-yl)-2-buten-1-one; para-methoxyacetophenone; para-methoxy-alpha-phenylpropene; methyl-2-n-hexyl-3-oxo-cyclopentane carboxylate; undecalactone gamma.

Additional examples of fragrance materials include, but are not limited to, orange oil; lemon oil; grapefruit oil; bergamot oil; clove oil; dodecalactone gamma; methyl-2-(2-pentyl-3-oxo-cyclopentyl) acetate; beta-naphthol methylether; methyl-beta-naphthylketone; coumarin; decylaldehyde; benzaldehyde; 4-tert-butylcyclohexyl acetate; alpha,alpha-dimethylphenethyl acetate; methylphenylcarbinyl acetate; Schiff's base of 4-(4-hydroxy-4-methylpentyl)-3-cyclohexene-1-carboxaldehyde and methyl anthranilate; cyclic ethyleneglycol diester of tridecandioic acid; 3,7-dimethyl-2,6-octadiene-1-nitrile; ionone gamma methyl; ionone alpha; ionone beta; petitgrain; methyl cedrylone; 7-acetyl-1,2,3,4,5,6,7,8-octahydro-1,1,6,7-tetramethyl-naphthalene; ionone methyl; methyl-1,6,10-trimethyl-2,5,9-cyclododecatrien-1-yl ketone; 7-acetyl-1,1,3,4,4,6-hexamethyl tetralin; 4-acetyl-6-tert-butyl-1,1-dimethyl indane; benzophenone; 6-acetyl-1,1,2,3,3,5-hexamethyl indane; 5-acetyl-3-isopropyl-1,1,2,6-tetramethyl indane; 1-dodecanal; 7-hydroxy-3,7-dimethyl octanal; 10-undecen-1-al; iso-hexenyl cyclohexyl carboxaldehyde; formyl tricyclodecan; cyclopentadecanolide; 16-hydroxy-9-hexadecenoic acid lactone; 1,3,4,6,7,8-hexahydro4,6,6,7,8,8-hexamethylcyclopenta-gamma-2-benzopyrane; ambroxane; dodecahydro-3a,6,6,9a-tetramethylnaphtho-[2,1b]furan; cedrol; 5-(2,2,3-trimethylcyclopent-3-enyl)-3-methylpentan-2-ol; 2-ethyl4-(2,2,3-trimethyl-3-cyclopenten-1-yl)-2-buten-1-ol; caryophyllene alcohol; cedryl acetate; para-tert-butylcyclohexyl acetate; patchouli; olibanum resinoid; labdanum; vetivert; copaiba balsam; fir balsam; and condensation products of: hydroxycitronellal and methyl anthranilate; hydroxycitronellal and indol; phenyl acetaldehyde and indol; 4-(4-hydroxy-4-methyl pentyl)-3-cyclohexene-1-carboxaldehyde and methyl anthranilate.

More examples of perfume components are geraniol; geranyl acetate; linalool; linalyl acetate; tetrahydrolinalool; citronellol; citronellyl acetate; dihydromyrcenol; dihydromyrcenyl acetate; tetrahydromyrcenol; terpinyl acetate; nopol; nopyl acetate; 2-phenylethanol; 2-phenylethyl acetate; benzyl alcohol; benzyl acetate; benzyl salicylate; benzyl benzoate; styrallyl acetate; dimethylbenzylcarbinol; trichloromethylphenylcarbinyl methylphenylcarbinyl acetate; isononyl acetate; vetiveryl acetate; vetiverol; 2-methyl-3-(p-tert-butylphenyl)-propanal; 2-methyl-3-(p-isopropylphenyl)-propanal; 3-(p-tert-butylphenyl)-propanal; 4-(4-methyl-3-pentenyl)-3-cyclohexenecarbaldehyde; 4-acetoxy-3-pentyltetrahydropyran; methyl dihydrojasmonate; 2-n-heptylcyclopentanone; 3-methyl-2-pentylcyclopentanone; n-decanal; n-dodecanal; 9-decenol-1; phenoxyethyl isobutyrate; phenylacetaldehyde dimethylacetal; phenylacetaldehyde diethylacetal; geranonitrile; citronellonitrile; cedryl acetal; 3-isocamphylcyclohexanol; cedryl methylether; isolongifolanone; aubepine nitrile; aubepine; heliotropine; eugenol; vanillin; diphenyl oxide; hydroxycitronellal ionones; methyl ionones; isomethyl ionomes; irones; cis-3-hexenol and esters thereof; indane musk fragrances; tetralin musk fragrances; isochroman musk fragrances; macrocyclic ketones; macrolactone musk fragrances; ethylene brassylate.

The perfumes useful in the present invention compositions are substantially free of halogenated materials and nitromusks.

Suitable solvents, diluents or carriers for perfumes ingredients mentioned above are for examples, ethanol, isopropanol, diethylene glycol, monoethyl ether, dipropylene glycol, diethyl phthalate, triethyl citrate, etc. The amount of such solvents, diluents or carriers incorporated in the perfumes is preferably kept to the minimum needed to provide a homogeneous perfume solution.

Perfume can be present at a level of from 0% to 10%, preferably from 0.1% to 5%, and more preferably from 0.2% to 3%, by weight of the finished composition. Fabric softener compositions of the present invention provide improved fabric perfume deposition.

(I)-Chelating Agents

The compositions and processes herein can optionally employ one or more copper and/or nickel chelating agents (“chelators”). Such water-soluble chelating agents can be selected from the group consisting of amino carboxylates, amino phosphonates, polyfunctionally-substituted aromatic chelating agents and mixtures thereof, all as hereinafter defined. The whiteness and/or brightness of fabrics are substantially improved or restored by such chelating agents and the stability of the materials in the compositions are improved.

Amino carboxylates useful as chelating agents herein include ethylenediaminetetraacetates (EDTA), N-hydroxyethylethylenediaminetriacetates, nitrilotriacetates (NTA), ethylenediamine tetraproprionates, ethylenediamine-N,N′-diglutamates, 2-hyroxypropylenediamine-N,N′-disuccinates, triethylenetetraaminehexacetates, diethylenetriaminepentaacetates (DETPA), and ethanoldiglycines, including their water-soluble salts such as the alkali metal, ammonium, and substituted ammonium salts thereof and mixtures thereof. Amino phosphonates are also suitable for use as chelating agents in the compositions of the invention when at least low levels of total phosphorus are permitted in detergent compositions, and include ethylenediaminetetrakis (methylenephosphonates), diethylenetriamine-N,N,N′,N″,N″-pentakis(methane phosphonate) (DETMP) and 1-hydroxyethane-1,1-diphosphonate (HEDP). Preferably, these amino phosphonates to not contain alkyl or alkenyl groups with more than 6 carbon atoms.

The chelating agents are typically used in the present rinse process at levels from 2 ppm to 25 ppm, for periods from 1 minute up to several hours' soaking.

The preferred EDDS chelator used herein (also known as ethylenediamine-N,N′-disuccinate) is the material described in U.S. Pat. No. 4,704,233, cited hereinabove, and has the formula (shown in free acid form):

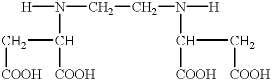

As disclosed in the patent, EDDS can be prepared using maleic anhydride and ethylenediamine. The preferred biodegradable [S,S] isomer of EDDS can be prepared by reacting L-aspartic acid with 1,2-dibromoethane. The EDDS has advantages over other chelators in that it is effective for chelating both copper and nickel cations, is available in a biodegradable form, and does not contain phosphorus. The EDDS employed herein as a chelator is typically in its salt form, i.e., wherein one or more of the four acidic hydrogens are replaced by a water-soluble cation M, such as sodium, potassium, ammonium, triethanolammonium, and the like. As noted before, the EDDS chelator is also typically used in the present rinse process at levels from 2 ppm to 25 ppm for periods from 1 minute up to several hours' soaking. At certain pH's the EDDS is preferably used in combination with zinc cations.

As can be seen from the foregoing, a wide variety of chelators can be used herein. Indeed, simple polycarboxylates such as citrate, oxydisuccinate, and the like, can also be used, although such chelators are not as effective as the amino carboxylates and phosphonates, on a weight basis. Accordingly, usage levels may be adjusted to take into account differing degrees of chelating effectiveness. The chelators herein will preferably have a stability constant (of the fully ionized chelator) for copper ions of at least 5, preferably at least 7. Typically, the chelators will comprise from 0.5% to 10%, more preferably from 0.75% to 5%, by weight of the compositions herein. Preferred chelators include DETMP, DETPA, NTA, EDDS and mixtures thereof.

(J)-Enzyme

The compositions and processes herein can optionally employ one or more enzymes such as lipases, proteases, cellulase, amylases and peroxidases. A preferred enzyme for use herein is a cellulase enzyme. Indeed, this type of enzyme will further provide a color care benefit to the treated fabric. Cellulases usable herein include both bacterial and fungal types, preferably having a pH optimum between 5 and 9.5. U.S. Pat. No. 4,435,307 discloses suitable fungal cellulases from Humicola insolens or Humicola strain DSM1800 or a cellulase 212-producing fungus belonging to the genus Aeromonas, and cellulase extracted from the hepatopancreas of a marine mollusk, Dolabella Auricula Solander. Suitable cellulases are also disclosed in GB-A-2.075.028; GB-A-2.095.275 and DE-OS-2.247.832. CAREZYME® and CELLUZYME® (Novo) are especially useful. Other suitable cellulases are also disclosed in WO 91/17243 to Novo, WO 96/34092, WO 96/34945 and EP-A-0,739,982. In practical terms for current commercial preparations, typical amounts are up to 5 mg by weight, more typically 0.01 mg to 3 mg, of active enzyme per gram of the detergent composition. Stated otherwise, the compositions herein will typically comprise from 0.001% to 5%, preferably 0.01%-1% by weight of a commercial enzyme preparation. In the particular cases where activity of the enzyme preparation can be defined otherwise such as with cellulases, corresponding-activity units are preferred (e.g. CEVU or cellulase Equivalent Viscosity Units). For instance, the compositions of the present invention can contain cellulase enzymes at a level equivalent to an activity from 0.5 to 1000 CEVU/gram of composition. Cellulase enzyme preparations used for the purpose of formulating the compositions of this invention typically have an activity comprised between 1,000 and 10,000 CEVU/gram in liquid form, around 1,000 CEVU/gram in solid form.

(K)-Other Optional Ingredients

The present invention can include optional components conventionally used in textile treatment compositions, for example: colorants; preservatives; surfactants; anti-shrinkage agents; fabric crisping agents; spotting agents; germicides; fungicides; anti-oxidants such as butylated hydroxy toluene, anti-corrosion agents, and the like.

The present invention can also include other compatible ingredients, including those as disclosed in copending applications Ser. Nos.: 08/372,068, filed Jan. 12, 1995, Rusche, et al.; 08/372,490, filed Jan. 12, 1995, Shaw, et al.; and 08/277,558, filed Jul. 19, 1994, Hartman, et al., incorporated herein by reference.

Fabric Softener Processing

Processing of the softening composition of the invention is made conventionally. A typical example for processing said softening composition can be found in WO 97/03169 incorporated herein by reference.

The synthesis of the mixtures of biodegradable fabric softening actives is described in pending application PCT US 97/03374 and WO 97/03169 incorporated herein by reference.

All percentages, weights, and ratios herein are by weight unless otherwise specified, and all numerical limits and numbers have the normal accuracy/variability associated with such numbers. All references herein are incorporated herein by reference, to the extent that they are relevant.

The following are non-limiting examples of the present invention:

Abbreviations used in the Examples

In the softening compositions, the abreviated component identification have the following meanings:

TMPD: 2,2,4-trimethyl-1,3-pentanediol

TEA DiEsterQuat: reaction product of (partly) unsaturated fatty acid with Triethanolamine, di-Me sulfate quaternised (as described in co-pending application PCT/US97/09130, page 41 synthesis Example 3)

DEA DiEsterQuat: reaction product of (partly) unsaturated fatty acid with Methyl di-Ethanolamine, MeCl quaternised (as described in WO97/03169 at page 108-109 under DEQA⁴)

Praepagen 3445: DiTallowDimethyl Ammonium Chloride, 72% solution in water and Isopropanol, supplied by Hoechst

Lutensol TO5: C13EO5 commercially available from BASF

Lutensol AO5: C13C15EO5 commercially available from BASF

Dowfax 9N5: nonylphenol 5EO commercially available from Dow

Genamin C200: coco amine ethoxylated with 20 EO commercially available from Hoechst

Genamin O-050: oleyl alcohol ethoxylated with 5 EO commercially available from Hoechst

Synthesis example of TEA DiEsterQuat

1)-Esterification:

571 grams of Canola fatty acid with an IV of about 100 and an Acid Value of about 196 as made according to Fatty Acid Compound Synthesis Example G is added into the reactor, the reactor is flushed with N2 and 149 grams of triethanolamine is added under agitation. The molar ratio of fatty acid to triethanol amine is of 2.0:1. The mixture is heated above 150 C. and the pressure is reduced to remove the water of condensation. The reaction is prolonged until an Acid Value of 3 is reached.

2)-Quaternization:

To the 698 grammes of the product of condensation 122 grams of dimethylsulfate is added under continuous agitation. The reaction mixture is kept above 50 C. and the reaction is followed by verifying the residual amine value. 820 grams of softener compound of the invention is obtained.

The quaternized material is optionally diluted with e.g. 15% of a 50:50 ethanol/hexyleneglycol mixture which lower the melting point of the material thereby providing a better ease in the handling of the material.

### EXAMPLE 1

The following compositions are in accordance with the invention.

| | 1 | 2 | 3 | 4 | 5 | 6 |
|---|---|---|---|---|---|---|
| TEA | 26% | 26% | 26% | 26% | 26% | 26% |
| DiEsterQuat | | | | | | |
| (100% active) | | | | | | |
| Ethanol | 2.5% | 2.5% | 2.5% | 2.5% | 2.5% | 4.5% |
| Hexyleneglycol | 2.5% | 2.5% | 2.5% | 2.5% | 2.5% | 2.5% |
| TMPD | 8% | 8% | 6% | 8% | 5% | — |
| 2-ethyl | — | — | — | — | — | 10% |
| 1,3 hexanediol | | | | | | |
| Lutensol TO5 | 3% | — | — | — | — | 4% |
| Dowfax 9N5 | — | 4% | — | — | — | — |
| Genamin C200 | — | — | 2% | — | — | — |
| Genapol O-050 | — | — | — | 4% | — | — |
| Lutensol AO5 | — | — | — | — | 3% | — |
| Perfume | 2% | 2% | 2% | 2% | 2% | 2% |
| demin water | Balance | Balance | Balance | Balance | Balance | Balance |

### EXAMPLE 2

The following compositions are in accordance with the invention.

| | 7 | 8 | 9 | 10 |
|---|---|---|---|---|
| TEA DiEsterQuat | 26% | 8% | — | — |
| (100% active) | | | | |
| DEA DiEsterQuat | — | — | — | 26% |
| (100% active) | | | | |
| Praepagen 3445 (72% | — | — | 36% | — |
| active) | | | | |
| Ethanol | 2.5% | 0.6% | — | 2.5% |
| Hexyleneglycol | — | 0.6% | — | 2.5% |
| Dipropyleneglycol | 3% | — | — | — |
| Butyl carbitol | 10% | — | — | — |
| TMPD | — | — | 8% | 8% |
| 1,2 hexanediol | — | 9% | — | — |
| Lutensol TO5 | 3% | 2% | 4% | 3% |
| Perfume | 2% | 0.7% | 2% | 2% |
| demin water | Balance | Balance | Balance | Balance |

1- A clear fabric softening composition comprising a fabric softening compound, a principal solvent having a ClogP of from 0.15 to 1.0 and a nonionic alkoxylated surfactant, wherein said nonionic surfactant is selected from:
i)-alkyl or alkylphenol alkoxylated with less than 9 alkoxy moieties;
ii)-alkylamine alkoxylated with at least 5 alkoxy moieties; and
iii)-block co-polymers obtained by copolymerisation of ethylene oxide and propylene oxide; and
iv)-mixtures thereof.

2- A composition according to claim 1, wherein said nonionic surfactant has a CMC of less than 10⁻²M.

3- A composition according to either one of claim 1 or 2, wherein said nonionic surfactant is an alkyl compound alkoxylated with less than 9 alkoxy moieties of formula:
R²—Y—(C₂H₄O)_{z}—H
wherein R² is selected from the group consisting of primary, secondary and branched chain alkyl and/or acyl hydrocarbyl groups; primary, secondary and branched chain alkenyl hydrocarbyl groups; and primary, secondary and branched chain alkyl- and alkenyl-substituted phenolic hydrocarbyl groups; said hydrocarbyl groups preferably having a hydrocarbyl chain length of from 6 to 20, preferably from 8 to 18 carbon atoms. More preferably the hydrocarbyl chain length is from 10 to 15 carbon atoms. In the general formula for the ethoxylated nonionic surfactants herein, Y is —O—, —C(O)O, and z is less than 9, preferably from 2 to 7, and more preferably is from 3 to 6.

4- A composition according to claim 3, wherein said nonionic is selected from straight-chain, primary alcohol alkoxylates, straight-chain, secondary alcohol alkoxylates, olefinic alkoxylates, branched chain alkoxylates, and mixtures thereof, preferably is a branched chain alkoxylates.

5- A composition according to any one of claims 1-4, wherein said softening compound has the formula: 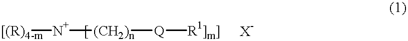
or the formula: 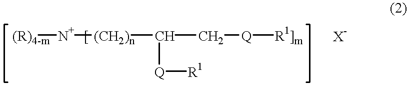
wherein Q is a carbonyl unit having the formula: 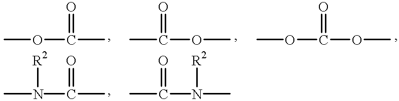
each R unit is independently hydrogen, C₁-C₆ alkyl, C₁-C₆ hydroxyalkyl, and mixtures thereof, preferably methyl or hydroxy alkyl; each R¹ unit is independently linear or branched C₁₁-C₂₂ alkyl, linear or branched C₁₁-C₂₂ alkenyl, and mixtures thereof, R² is hydrogen, C₁-C₄ alkyl, C₁-C₄ hydroxyalkyl, and mixtures thereof; X is an anion which is compatible with fabric softener actives and adjunct ingredients; the index m is from 1 to 4, preferably 2; the index n is from 1 to 4, preferably 2.

6- A composition according to any one of claims 1-5, wherein said fabric softener active is present in an amount of from 15% to 70%, by weight of the composition.

7- A fabric softening composition according to any one of claims 1-6, wherein said principal solvent is selected from mono-ols, C6 diols, C7 diols, octanediol isomers, butanediol derivatives, trimethylpentanediol isomers, ethylmethylpentanediol isomers, propyl pentanediol isomers, dimethylhexanediol isomers, ethylhexanediol isomers, methylheptanediol isomers, octanediol isomers, nonanediol isomers, alkyl glyceryl ethers, di(hydroxy alkyl) ethers, and aryl glyceryl ethers, aromatic glyceryl ethers, alicyclic diols and derivatives, C₃C₇ diol alkoxylated derivatives, aromatic diols, and unsaturated diols, and mixtures thereof.

8- A fabric softening composition according to claim 7, wherein the principal solvent is selected from 2,2,4-trimethyl-1,3-pentanediol, ethoxylates of 2,2,4-trimethyl-1,3-pentanediol, 1,2 hexanediol, 2-ethyl-1,3-hexanediol, phenoxyethanol, butyl carbitol and mixtures thereof.

9- A fabric softening composition according to any one of claims 1-8, wherein said principal solvent is present in an amount of less than 40% by weight, preferably from 5% to 25%, more preferably from 6% to 12%, by weight of the composition.

10- A fabric softening composition according to any one of claims 1-9, wherein said composition comprises an effective amount, sufficient to improve clarity, of low molecular weight water soluble solvents selected from the group consisting of: ethanol, isopropanol, propylene glycol, 1,2-propanediol; 1,3-propanediol, propylene carbonate, 1,4 cyclohexanedimethanol and mixtures thereof, said water soluble solvents being at a level that will not form clear compositions by themselves.

11- A fabric softening composition according to any one of claims 1-10, wherein said composition has a pH of from 2 to 5.

12- A method of treating fabrics which comprises the step of contacting the fabrics in an aqueous medium containing the softening composition as defined in any one of claims 1-11.
